(19) United States
(12) Patent Application Publication
(10) Pub. No.: US 2011/0183209 A1
(43) Pub. Date: Jul. 28, 2011

(54) HIGH CAPACITY LITHIUM-ION ELECTROCHEMICAL CELLS

(75) Inventors: Leif Christensen, St. Paul, MN (US); Jerome E. Scanlan, St. Paul, MN (US)

(73) Assignee: 3M Innovative Properties Company

(21) Appl. No.: 12/694,617

(22) Filed: Jan. 27, 2010

(51) Int. Cl. H01M 4/58; H01M 4/00; H01M 6/00

(52) U.S. Cl. 429/223; 429/231.95; 429/231.8; 29/623.1

(57) ABSTRACT

A lithium-ion electrochemical cell is provided that has high total energy, high energy density and good performance upon repeated charge-discharge cycles. The cell includes a composite positive electrode that comprises a metal oxide electrode material, a composite negative electrode that comprises a alloy anode active material having a first cycle irreversible capacity of 10 percent or higher and an electrolyte. The first cycle irreversible capacity of the composite positive electrode is within 40 percent of the first cycle irreversible capacity of the composite negative electrode.

### FIELD

The present disclosure relates to lithium-ion electrochemical cells.

### BACKGROUND

Lithium-ion electrochemical cells operate by reversible lithium intercalation and extraction into both the active negative electrode material, (typically carbon or graphite), and the active positive electrode material (typically, layered or spinel-structured transition metal oxides). The energy density of lithium-ion electrochemical cells has been increased by densifying the negative and positive electrodes and utilizing active electrode materials that have low irreversible capacity. For example, in current high energy cells, the positive electrode material typically has less than about 20% porosity, and the negative electrode material typically has less than about 15% porosity with each having an irreversible capacity of less than about 4-8%.

Lithium-ion cells that have high total energy, energy density, and specific discharge capacity upon cycling, are described, for example, in U.S. Pat. Publ. No. 2009/0263707 (Buckley et al.). These cells use high energy positive active materials, graphite or carbon negative active materials, and very thick active material coatings. However, since the active material coatings are thick, it is difficult to make wound cells, without the coatings flaking off of the current collector, or the coatings fracturing.

Recently, high energy lithium-ion cells have been constructed using alloy active materials as the negative electrode. Such materials have higher gravimetric and volumetric energy density than graphite alone. Alloy active negative materials, however, undergo large volumetric changes associated with lithiation and delithiation. To minimize such large volumetric changes alloy active materials can be made that include both electrochemically active phases (phases that are reactive with lithium) and electrochemically inactive phases (dilutive phases that are not reactive with lithium). Also, negative electrodes based on alloy active materials tend to have high porosity as coated, and can only be slightly densified by calendaring. It can, therefore, be beneficial to blend alloy active material with graphite as well as a conductive diluent and binder, to form a composite electrode that can be appropriately densified. The amount of graphite blended with the alloy can be from about 35 weight percent (wt %) to about 65 wt %. The amount of conductive diluent (carbon black, metal fibers, etc) typically can range from about 2 wt % to about 5 wt %, and the amount of binder typically used ranges from about 2 wt % to about 8 wt %.

### SUMMARY

There is a need for high capacity, high energy lithium-ion electrochemical cells. There is also a need for lithium-ion electrochemical cells that can be charged and discharged many times without significant loss of capacity.

In one aspect, a lithium-ion electrochemical cell is provided that includes a composite positive electrode having a first cycle irreversible capacity that comprises a metal oxide composite active material, a negative composite electrode having a first cycle irreversible capacity of 10 percent or higher that comprises an alloy active material, and an electrolyte, wherein the first cycle irreversible capacity of the positive electrode is within 40 percent of the first cycle irreversible capacity of the negative electrode. The positive electrodes can comprise a metal oxide material that can include cobalt, nickel, manganese, lithium, or combinations thereof. The negative electrode can include an alloy active material that can include silicon, tin, or a combination thereof, optionally aluminum, at least one transition metal, optionally yttrium, a lanthanide element, an actinide element, or combinations thereof, and, optionally, carbon.

In another aspect, a method of making an electrochemical cell having high capacity is provided that includes providing a negative electrode having a first cycle irreversible capacity of 10 percent or higher and comprising an alloy active material, selecting a positive electrode having a first cycle irreversible capacity within 40 percent of the first cycle irreversible capacity of the negative electrode, and combining the negative electrode, the positive electrode and an electrolyte to form an electrochemical cell.

In this disclosure:

“active” or “electrochemically active” refers to a material that can undergo lithiation and delithiation by reaction with lithium;

“alloy active material” refers to a composition of two or more elements, at least one of which is a metal, and where the resulting material is electrochemically active;

“composite (positive or negative) electrode” refers to the active and inactive material that make up the coating that is applied to the current collector to form the electrode and includes, for example, conductive diluents, adhesion-promoters, and binding agents;

“first cycle irreversible capacity” is the total amount of lithium capacity of an electrode that is lost during the first charge/discharge cycle which is expressed in mAh, or as a percentage of the total electrode, or, active component capacity;

“porosity” refers to the percent of a volume of material that is air; and

“specific capacity” is the capacity of an electrode material to hold lithium and is expressed in mAh/g.

The provided lithium-ion electrochemical cells can provide high volumetric and specific energy. In small cells like 18650 cylindrical format, cell capacities as high as 2.8 Ah, 3.0 Ah, 3.5 Ah, or even higher, may be possible. The provided lithium-ion electrochemical cells can retain this high capacity after repeated charge-discharge cycling.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIG. 1 is a graph of cell voltage vs. specific capacity (mAh/g) of a hypothetical provided lithium-ion electrochemical cell.

FIG. 2 is a composite graph of normalized cell discharge capacity vs. cycle number for several embodiments of provided lithium-ion electrochemical cells.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The provided lithium-ion electrochemical cells include a positive electrode having a first cycle irreversible capacity comprising a metal oxide active material, and a negative electrode having a first cycle irreversible capacity of 10 percent or higher comprising an anode active alloy material, and an electrolyte. Typically, the electrode materials are mixed with additives and then coated onto current collectors such as those described later in this disclosure, to form a composite electrode. To make an electrochemical cell, at least one positive electrode and at least one negative electrode are placed in proximity and separated by a thin porous membrane or separator. A common format for lithium-ion cells is an 18650 cylindrical cell (18 mm in diameter and 65 mm in length) or a 26700 cylindrical cell (26 mm in diameter and 70 mm long) in which a positive electrode-separator-negative electrode “sandwich” is rolled into a cylinder and placed in a cylindrical canister along with an electrolyte. Another common format is a flat cell in which the positive electrode-separator-negative electrode “sandwich” is layered into a flat, rectangular shape and placed in a container of the same shape that also contains electrolyte.

Typically, commercial 18650 lithium-ion electrochemical cells have a capacity of around 2.6 amp-hours (Ah). Lithium-ion electrochemical cells with this amount of capacity have been attained by compressing (calendaring) a composite positive electrode comprising an active cathode material such as LiCoO₂ and compressing a composite negative electrode comprising an active anode material such as graphite before winding to make the cell. After compression, the positive electrode generally has a porosity of about 20% void volume or less and the graphite negative electrode generally has a porosity of about 15% void volume or less. These materials each have very low irreversible capacities of around 4-6%. However, lithium-ion electrochemical cells using graphite as a negative electrode material limit the capacity of the 18650 cell format to around 2.6 Ah.

Attempts have been made to further increase capacity by coating more (thicker and/or denser) active positive electrode material onto the positive composite electrode. A disclosure of this approach can be found, for example, in U.S. Pat. Publ. No. 2009/0263707 (Buckley et al.). Another approach to increasing the capacity of lithium-ion electrochemical cells is to use alloy negative electrode materials since they can incorporate much more lithium than graphite. Unfortunately, alloy negative electrode materials can have high porosity when coated and they tend to have significantly higher first cycle irreversible capacities than graphite—typically from about 10% to even greater than 25% capacity loss during the first cycle. It has been found, however, that the most effective packing of energy into a lithium-ion cell occurs when the first cycle irreversible capacity of the anode and first cycle irreversible capacity of the cathode is closely matched. Efforts have been made to lower the first cycle irreversible capacity of alloy anodes, to better match LiCoO₂ positive electrodes—a very difficult task. However, several other high capacity positive electrode materials have significantly higher irreversible capacity than LiCoO₂ and have been considered poor matches with graphite as far as irreversible capacity is concerned. However, these other materials are better matched with alloy anode type electrodes.

Additionally, alloy negative electrode materials tend to cycle poorly when used in a cell with a high density composite positive electrode such as LiCoO₂.

Furthermore, surprisingly, the porosity of the composite positive electrode significantly affects the long term cycle life of a lithium-ion electrochemical cell with an alloy composite negative electrode. For example, alloy negative electrode materials tend to cycle poorly when used in a cell with a high density composite positive electrode such as comprising LiCoO₂.

Therefore, the cathode active materials must be chosen to provide high specific and volumetric capacity, provide irreversible capacity matching with the active anode material, and provide a composite positive electrode with a porosity greater than 20%. Using this strategy, it is possible to realize lithium-ion electrochemical cells, for example of the 18650 format, that can have up to about 3.0 Ah, up to about 3.5 Ah, or even higher total cell capacity, and long cycle life. The provided lithium-ion electrochemical cells have composite positive electrodes that include an active metal oxide material having about the same first cycle irreversible capacity as the active alloy composite negative electrodes.

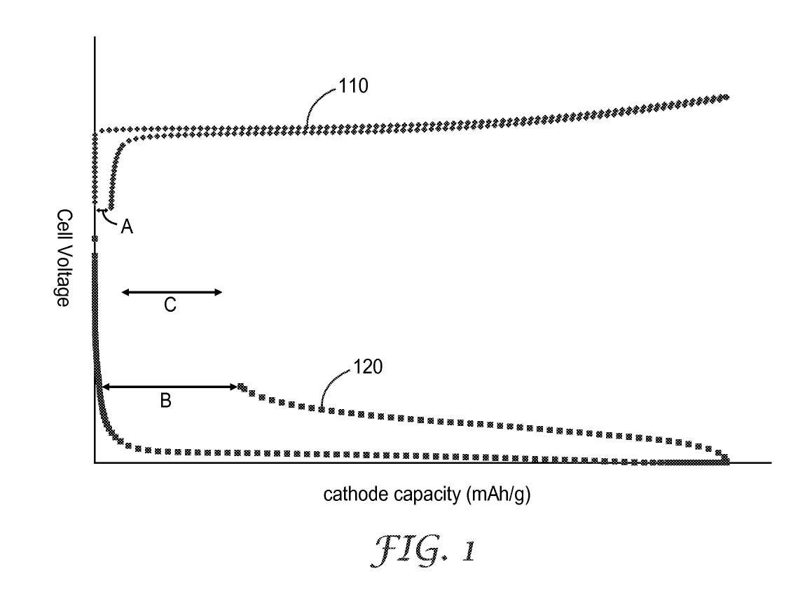

This principle is illustrated in FIG. 1, which is a graph of cell voltage vs. electrode capacity of a hypothetical provided lithium-ion electrochemical cell. The graph displays the first cycle capacity of a typical positive electrode 110 and the first cycle capacity of a typical negative electrode 120 in a lithium-ion electrochemical cell. After the first charge-discharge cycle, the positive electrode has a first cycle irreversible capacity loss shown by arrow “A” and the negative electrode has a first cycle irreversible loss shown by arrow “B”. The total irreversible capacity loss of the cell is the difference between “A” and “B” and is represented by “C”. “C” is wasted capacity in the cell and limits the total capacity of the cell. If “A” and “B” are more closely matched in terms of first cycle irreversible capacity loss then “C” gets smaller. The optimal situation is where “A” and “B” have about the same value. In this case “C” is at a minimum and the cell can use all of its capacity in future charge-discharge cycles. Therefore, when designing a lithium-ion electrochemical cell it is advantageous to choose electrode components that will ensure that the first cycle irreversible capacities of the composite positive electrode and of the composite negative electrode are closely matched. Table 1 includes a variety of active cathode and active alloy anode materials and their intrinsic reversible capacities (expressed as mAh/g) as well as their irreversible capacities (expressed as a percentage of total capacity).

TABLE 1
Capacities and Irreversible Capacities of Electrode Materials

| Alloy Active Materials (Negative) | | | Metal Oxide Active Materials (Positive) | | |
|---|---|---|---|---|---|
| | Reversible Specific | Irreversible | | Reversible Specific | Irreversible |
| Composition | Capacity (mAh/g) | Capacity (%) | Composition | Capacity (mAh/g) | Capacity (%) |
| Compound A | 800 | 15 | Compound E | 145 | 4 |
| Compound B | 800 | 10 | Compound F | 160 | 10 |
| Compound C | 1000 | 20 | Compound G | 178 | 17 |
| Compound D | 519 | 29 | Compound H | 190 | 13 |
| | | | Compound I | 220 | 12 |
| | | | Compound J | 298 | 26 |

Compound A - Si₆₀Al₁₄Fe₈Ti₁Sn₇Mm₁₀
Compound B - Si₇₁Fe₂₅Sn₄
Compound C - Si₅₇Al₂₈Fe₁₅
Compound D - Sn₃₀Co₃₀C₄₀
Compound E - LiCoO₂
Compound F - Li[Ni_{0.33}Mn_{0.33}Co_{0.33}]O₂
Compound G - Li[Ni_{0.5}Mn_{0.3}Co_{0.2}]O₂
Compound H - Li[Ni_{0.66}Mn_{0.34}]O₂
Compound I - Li[Li_{0.05}Ni_{0.42}Mn_{0.53}]O₂
Compound J - Li[Li_{0.20}Ni_{0.13}Co_{0.13}Mn_{0.54}]O₂

Referring to Table 1, it is advantageous to make a high capacity (energy) lithium-ion electrochemical cell where the irreversible capacity of the active positive electrode material (expressed as a percentage) is close to the irreversible capacity of the active negative electrode material (also expressed as a percentage). Other factors, besides the intrinsic irreversible capacity of the active electrode material, like active blending additives, conductive diluents, and even certain binders may also contribute to the irreversible capacity of the composite electrodes, and may even be used to “fine tune” the matched composite electrodes.

The provided lithium-ion electrochemical cells include a positive electrode, having a first cycle irreversible capacity that comprises a metal oxide cathode active material. The metals can include, for example, cobalt, nickel, manganese, lithium, vanadium, iron, copper, zinc and combinations thereof. Positive electrodes metal oxide cathode active materials useful in the provided electrochemical cells can include, for example, LiCo_{0.2}Ni_{0.8}O₂, LiNiO₂, LiFePO₄, LiMnPO₄, LiCoPO₄, LiMn₂O₄, and LiCoO₂; the positive electrode compositions that include mixed metal oxides of cobalt, manganese, and nickel such as those described in U.S. Pat. Nos. 6,964,828 and 7,078,128 (Lu et al.); and nanocomposite positive electrode compositions such as those described in U.S. Pat. No. 6,680,145 (Obrovac et al.). Other exemplary cathode active materials can include LiNi_{0.5}Mn_{1.5}O₄ and LiVPO₄F. Additional useful metal oxide active materials can be found, for example, in Japanese Pat. Publ. No. 11-307094 (Takahiro et al.), U.S. Pat. Nos. 5,160,172 and 6,680,143 (both Thackeray et al.); 7,358,009 and 7,635,536 (both Johnson et al.); U.S. Pat. Publ. Nos. 2008/0280205, and 2009/0087747 (Jiang et al.); 2009/0239148 (Jiang); 2009/0081529 (Thackeray); and U.S. Ser. No. 12/176,694, filed Apr. 8, 2009 (Jiang).

Exemplary metal oxide cathode active materials include materials that have the formula, Li[Li_{(1-2y)/3}M¹_{y}Mn_{(2-y)/3}]O₂, wherein 0.083<y<0.5 and M¹ represents Ni, Co or a combination thereof, and wherein the metal oxide composite active material is in the form of a single phase having an O3 crystal structure. These metal oxide composite active materials are particularly useful when the metal oxide composite active material does not undergo a phase transformation to a spinel crystal structure when incorporated into a lithium-ion electrochemical cell with an anodic material, such as lithium, and cycled from an upper voltage ranging between 4.4 V to 4.8 V to a lower voltage ranging from 2.0 V to 3.0 V for 100 charge-discharge cycles at 30° C.

Exemplary metal oxide composite active materials also include materials that have the formula, Li[M²_{y}M³_{1-2y}Mn_{y}]O₂, wherein 0.167<y<0.5, M² represents Ni or Ni and Li, and M³ represents Co, and wherein said positive electrode composition is in the form of a single phase having an O3 crystal structure, and Li[M⁴_{y}M⁵_{1-2y}Mn_{y}]O₂, wherein 0.167<y<0.5, M⁴ represents Ni and M⁵ represents Co or Co and Li, and wherein said positive electrode composition is in the form of a single phase having an O3 crystal structure. These materials are also particularly useful when the metal oxide active material does not undergo a phase transformation to a spinel crystal structure when incorporated into a lithium-ion electrochemical cell with an anodic material, such as lithium, and is cycled from an upper voltage ranging between 4.4 V to 4.8 V to a lower voltage ranging from 2.0 V to 3.0 V for 100 charge-discharge cycles at 30° C.

In other embodiments, the provided lithium-ion electrochemical cells can include positive electrodes that have metal oxide cathode active materials that include, for example, Li[Ni_{0.67}Mn_{0.33}]O₂, Li[Ni_{0.50}Mn_{0.30}Co_{0.20}]O₂, Li[Ni_{0.33}Mn_{0.33}Co_{0.33}]O₂, or Li[Ni_{0.42}Mn_{0.42}Co_{0.16}]O₂. In some embodiments, the positive electrodes can have excess lithium—2 mole % or more, 5 mole % or more, 10 mole % or more, or even 20 mole % or more. Useful metal oxide composite active materials can be in an O3 layered structure. In the O3 structure, these composites have alternating layers of lithium-metal-oxygen-metal-lithium. The layered structure facilitates reversible movement of lithium into and out of the structure.

The provided lithium-ion electrochemical cells also include a negative electrode having a first cycle irreversible capacity of 10 percent or higher and comprise an alloy active material. Useful alloy active materials include silicon, tin, or a combination thereof. Additionally the alloys include at least one transition metal. Suitable transition metals include, but are not limited to, titanium, vanadium, chromium, manganese, iron, cobalt, nickel, copper, zirconium, niobium, molybdenum, tungsten, and combinations thereof. Some embodiments of these compositions can also contain indium, niobium, silicon, zinc, silver, lead, iron, germanium, titanium, molybdenum, aluminum, phosphorus, gallium, and bismuth, and combinations thereof. The alloy active materials can also, optionally, include aluminum, indium, carbon, or one or more of yttrium, a lanthanide element, an actinide element or combinations thereof. Suitable lanthanide elements include lanthanum, cerium, praseodymium, neodymium, promethium, samarium, europium, gadolinium, terbium, dysprosium, holmium, erbium, thulium, ytterbium, and lutetium. Suitable actinide elements include thorium, actinium, and protactinium. Some alloy compositions contain a lanthanide elements selected, for example, from cerium, lanthanum, praseodymium, neodymium, or a combination thereof.

Typical alloy active materials can include greater than 55 mole percent silicon. They can also include transition metals selected from titanium, cobalt, iron, and combinations thereof. Useful alloy active materials can be selected from materials that have the following components, SiAlFeTiSnMm, SiFeSn, SiAlFe, SnCoC, and combinations thereof where “Mm” refers to a mischmetal that comprises lanthanide elements. Some mischmetals contain, for example, 45 to 60 weight percent cerium, 20 to 45 weight percent lanthanum, 1 to 10 weight percent praseodymium and, 1 to 25 weight percent neodymium. Other mischmetals contains 30 to 40 weight percent lanthanum, 60 to 70 weight percent cerium, less than 1 weight percent praseodymium, and less than 1 weight percent neodymium. Still other mischmetals contains 40 to 60 weight percent cerium and, 40 to 60 weight percent lanthanum. The mischmetal often includes small impurities (e.g., less than 1 weight percent, less than 0.5 weight percent, or less than 0.1 weight percent) such as, for example, iron, magnesium, silicon, molybdenum, zinc, calcium, copper, chromium, lead, titanium, manganese, carbon, sulfur, and phosphorous. The mischmetal often has a lanthanide content of at least 97 weight percent, at least 98 weight percent, or at least 99 weight percent. One exemplary mischmetal that is commercially available from Alfa Aesar, Ward Hill, Mass. with 99.9 weight percent purity contains approximately 50 weight percent cerium, 18 weight percent neodymium, 6 weight percent praseodymium, 22 weight percent lanthanum, and 3 weight percent other rare earths.

Exemplary active alloy materials include Si₆₀Al₁₄Fe₈TiSn₇Mm₁₀, Si₇₁Fe₂₅Sn₄, Si₅₇Al₂₈Fe₁₅, Sn₃₀Co₃₀C₄₀, or combinations thereof. The active alloy materials can be a mixture of an amorphous phase that includes silicon and a nanocrystalline phase that includes an intermetallic compound that comprises tin. Exemplary alloy active materials useful in the provided lithium-ion electrochemical cells can be found, for example, in U.S. Pat. Nos. 6,680,145 (Obrovac et al.), 6,699,336 (Turner et al.), and 7,498,100 (Christensen et al.) as well as in U.S. Pat. Publ. Nos. 2007/0148544 (Le), 2007/0128517 (Christensen et al.), 2007/0020522, and 2007/0020528 (both Obrovac et al.).

Provided electrochemical cells require an electrolyte. A variety of electrolytes can be employed. Representative electrolytes can contain one or more lithium salts and a charge-carrying medium in the form of a solid, liquid or gel. Exemplary lithium salts are stable in the electrochemical window and temperature range (e.g. from about −30° C. to about 70° C.) within which the cell electrodes can operate, are soluble in the chosen charge-carrying media, and perform well in the chosen lithium-ion cell. Exemplary lithium salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof. Exemplary electrolytes are stable without freezing or boiling in the electrochemical window and temperature range within which the cell electrodes can operate, are capable of solubilizing sufficient quantities of the lithium salt so that a suitable quantity of charge can be transported from the positive electrode to the negative electrode. Exemplary solid electrolytes include polymeric media such as polyethylene oxide, fluorine-containing copolymers, polyacrylonitrile, combinations thereof and other solid media that will be familiar to those skilled in the art. Exemplary liquid electrolytes include ethylene carbonate, propylene carbonate, dimethyl carbonate, diethyl carbonate, ethyl-methyl carbonate, butylene carbonate, vinylene carbonate, fluoroethylene carbonate, fluoropropylene carbonate, γ-butyrolactone, methyl difluoroacetate, ethyl difluoroacetate, dimethoxyethane, diglyme (bis(2-methoxyethyl)ether), tetrahydrofuran, dioxolane, combinations thereof and other media that will be familiar to those skilled in the art. Exemplary electrolyte gels include those described in U.S. Pat. Nos. 6,387,570 (Nakamura et al.) and 6,780,544 (Noh). The electrolyte can include other additives that will familiar to those skilled in the art. For example, the electrolyte can contain a redox chemical shuttle such as those described in U.S. Pat. Nos. 5,709,968 (Shimizu), 5,763,119 (Adachi), 5,536,599 (Alamgir et al.), 5,858,573 (Abraham et al.), 5,882,812 (Visco et al.), 6,004,698 (Richardson et al.), 6,045,952 (Kerr et al.), and 6,387,571 B1 (Lain et al.); and in U.S. Pat. Appl. Publ. Nos. 2005/0221168 A1, 2005/0221196 A1, 2006/0263696 A1, and 2006/0263697 A1 (all to Dahn et al.).

Composite electrodes can contain additives such as will be familiar to those skilled in the art. The electrode composition can include an electrically conductive diluent to facilitate electron transfer between the composite electrode particles and from the composite to a current collector. Electrically conductive diluents can include, but are not limited to, carbon black, metal, metal nitrides, metal carbides, metal silicides, and metal borides. Representative electrically conductive carbon diluents include carbon blacks such as SUPER P and SUPER S (both from MMM Carbon, Belgium), SHAWANIGAN BLACK (Chevron Chemical Co., Houston, Tex.), acetylene black, furnace black, lamp black, graphite, carbon fibers and combinations thereof.

The electrode composition can include an adhesion promoter that promotes adhesion of the composition and/or electrically conductive diluent to the binder. The combination of an adhesion promoter and binder can help the electrode composition better accommodate volume changes that can occur in the composition during repeated lithiation/delithiation cycles. Alternatively, the binders themselves can offer sufficiently good adhesion to metals and alloys so that addition of an adhesion promoter may not be needed. If used, an adhesion promoter can be made a part of the binder itself (e.g., in the form of an added functional group), can be a coating on the composite particles, can be added to the electrically conductive diluent, or can be a combination of such measures. Examples of adhesion promoters include silanes, titanates, and phosphonates as described in U.S. Pat. Appl. Publ. No. 2004/0058240 A1 (Christensen).

Objects and advantages of this invention are further illustrated by the following examples, but the particular materials and amounts thereof recited in these examples, as well as other conditions and details, should not be construed to unduly limit this invention.

### EXAMPLES

### Comparative Example 1

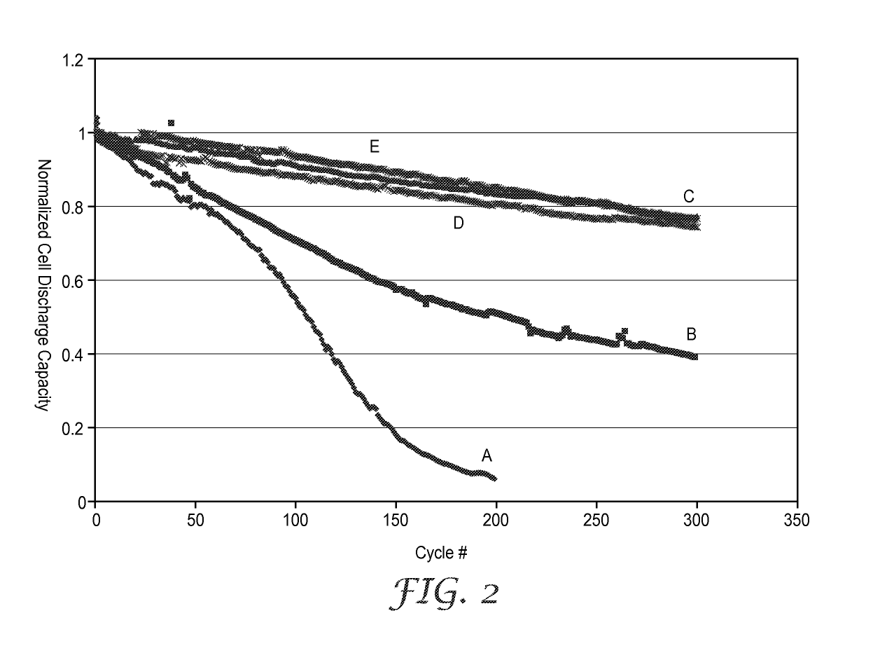

2 kg of the alloy negative electrode material, Si_{66.6}Fe_{11.2}T_{11.2}C_{11.2}, was produced by high energy ball milling using the same procedure as disclosed in the Example section of U.S. Pat. Publ. No. 2007/0148544 (Le). The alloy (63.4 wt %) was blended with 33.6 wt % MCMB 6-28, and 4 wt % Li-PAA (250,000 MW poly acrylic acid (Aldrich) neutralized with LiOH.H₂0 (Aldrich)) to form an aqueous suspension. This suspension was coated using a knife coater (Hirano) on Cu foil. The coating was slit into electrodes and calendared. Matching lithium cobalt oxide positive electrodes with a density of 3.75 g/cc and a porosity of 20% were acquired from E-one Moli, Vancouver, Canada. The positive and negative electrodes were wound into an 18650 cell format, using CELGARD 2400 (25 μm thick separator), and cycled between 4.2 V and 2.8 V for 200 cycles. The cycling results are displayed in FIG. 2. The normalized cell discharge capacity (mAh) vs. cycle number of this cell is displayed as Graph A of FIG. 2.

### Comparative Example 2

2 kg of the alloy material, Si₆₀Al₁₄Fe₈TiSn₇Mm₁₀, were produced by melt spinning 46.5 wt % alloy (produced according to the procedure disclosed in Example 1 of U.S. Pat. Publ. No. 2007/0020521 (Obrovac et al.) was mixed with 46.5 wt % MCMB 6-28, 2% KETCHEN black and 5% Li-PAA. (as above) to form an aqueous dispersion, which was coated onto copper foil and slit into electrodes. Matching lithium cobalt oxide positive electrodes having a density of 3 g/cc and a porosity of 28% were acquired from GP (Taiwan). The positive and negative electrodes were wound into 18650 cell format using CELGARD 2400 separator. The cells were cycled between 4.2 and 2.8. The normalized cell discharge capacity (mAh) vs. cycle number of this cell is displayed as Graph B of FIG. 2.

### Example 1

2 kg of the negative active alloy, Si₆₀Al₁₄Fe₈TiSn₇Mm₁₀, was produced as in Comparative Example 2. 46.5 wt % of the alloy was mixed with 46.5 wt % MAG E graphite, (available from Hitachi Chemical, Tokyo, JAPAN), 2 wt % KETCHEN Black (Akzo Nobel Polymer Chemical LLC, Chicago, Ill.) and 5 wt % lithium polyacrylate (made according to the procedure disclosed in Preparatory Example 2 of U.S. Pat. Publ. No. 2008/0187838 (Le). The aqueous suspension was coated onto copper foil and slit into electrodes. The electrodes were calendared to a porosity of 20%. A layered positive electrode material of the formula Li[Ni_{2/3}Mn_{1/3}]O₂ was produced in the following fashion. To a stirred tank reactor was added 4 l of a 1M NH₃OH solution in deionized (DI) water under an atmosphere of argon. The solution was heated to 60° C. and stirred at 1000 revolutions per minute. A 4 L aqueous solution of 2M NiSO₄ and MnSO₄ (2 to 1 molar ratio) was added at a rate of 5.1 ml/min. A concentrated solution of NH₃OH (28% NH₃) was then added at a rate of 0.44 ml/min, and a 50% NaOH solution was added at a rate so as to maintain a pH of 10.1. The addition was continued for 12 hrs. Then the solution was stirred for and additional 12 hrs. After stirring the dispersion settled, the precipitated metal hydroxide was washed in a pressure filter with 30 L of distilled water. The metal hydroxide was dried at 110° C. for 24 hrs. Following drying, the metal hydroxide was mixed with 1.01 molar equivalent of LiOH.H₂0 and fired for 4 hrs at 500° C. followed by 12 hrs at 900° C., to produce Li[Ni_{2/3}Mn_{1/3}]O₂. 3 kg of this material (92.5 wt %) was mixed with SUPER P (2.5 wt %) and polyvinylidene fluoride (PVDF)(5 wt %, Aldrich Chemical, Milwaukee, Wis.) to form a suspension. The suspension was coated onto aluminum foil using a knife coater (Hirano) to produce a coated film. The coated film was slit and calendared into electrodes having a density of 2.8 g/cc and a porosity of 36%. The positive electrodes were wound into 18650 format cells with the composite alloy negative electrode from Comparative Example 2, and the cells cycled between 4.35 and 2.8 V. The normalized cell discharge capacity (mAh) vs. cycle number of this cell is displayed as Graph C of FIG. 2.

### Example 2

An alloy negative electrode based on Si₆₀Al₁₄Fe₈TiSn₇Mm₁₀ was coated as in Example 1 above. A layered positive electrode material of the formulation Li[Ni_{0.5}Mn_{0.3}Co_{0.2}]O₂ was produced following the process described in Example 1 above, and was coated, slit and calendered into electrodes having a porosity of 36%. The positive electrodes were wound into 18650 format cells with the composite alloy negative electrodes, and the cells cycled between 4.35 and 2.8 V. The normalized cell discharge capacity (mAh) vs. cycle number of this cell is displayed as Graph D of FIG. 2.

### Example 3

An alloy negative electrode based on Si₆₀Al₁₄Fe₈TiSn₇Mm₁₀ was coated as in Example 1 above. A layered positive electrode material of the formulation Li[Ni_{1/3}Mn_{1/3}Co_{1/3}]O₂, commercially available from 3M, St. Paul, Minn. under the trade designation, BC618C, was coated, slit and calendared into electrodes having a porosity of 28%. The positive electrodes were wound into 18650 format cells with the composite alloy negative electrodes, and the cells cycled between 4.30 and 2.8V. The normalized cell discharge capacity (mAh) vs. cycle number of this cell is displayed as Graph E of FIG. 2.

FIG. 2 is a composite graph of normalized cell discharge capacity vs. cycle number for the exemplary cells of Comparative Examples 1 and 2 as well as Examples 1-3. Comparative Example 1 is a graph of the cycling performance of a cell that includes an alloy active negative electrode and lithium cobalt oxide (with a porosity of 20%) as a positive electrode. As can be seen from Graph A of FIG. 2, capacity fade of the cell is severe. Comparative Example 2 is a performance graph of a lithium-ion electrochemical cell that has the same negative electrode as that in the cell of Comparative Example 1 but has a lithium cobalt oxide positive electrode with a porosity of 25% that allows for more cell expansion upon intercalation of lithium during cycling. As can be seen from Graph B, capacity fade is slower than that of Comparative Example 1 but is significant over 300 cycles.

Example 1 (performance displayed by Graph C) has an alloy negative electrode negative electrode material and a mixed metal oxide positive material with a porosity of 36%. The cell made with these electrodes cycled much better and retained about 78% of its initial capacity after 300 cycles. Examples 2 and 3 (performance displayed by Graph D) has the same negative electrode as Example 1 but with a different lithium mixed metal oxide positive electrode with 36% and 28% porosities respectively. These Examples also cycle with retention of about 78% of initial capacity after 300 cycles.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

What is claimed is:

1. A lithium-ion electrochemical cell comprising:
a composite positive electrode having a first cycle irreversible capacity that comprises a metal oxide active material;
a composite negative electrode having a first cycle irreversible capacity of 10 percent or higher that comprises an alloy active material; and
an electrolyte,
wherein the first cycle irreversible capacity of the composite positive electrode is within 40 percent of the first cycle irreversible capacity of the composite negative electrode.

2. A lithium-ion electrochemical cell according to claim 1, wherein the composite negative electrode has a first cycle irreversible capacity of 15 percent or higher.

3. A lithium-ion electrochemical cell according to claim 1, wherein the metal oxide active material comprises cobalt, nickel, manganese, lithium, or combinations thereof.

4. A lithium-ion electrochemical cell according to claim 3, wherein the metal oxide active material has the formula, Li[Li_{(1-2y)/3}M¹_{y}Mn_{(2-y)/3}]O₂, wherein 0.083<y<0.5 and M¹ represents Ni, Co or a combination thereof, and wherein the metal oxide active material is in the form of a single phase having an O3 crystal structure.

5. A lithium-ion electrochemical cell according to claim 4, wherein the metal oxide active material does not undergo a phase transformation to a spinel crystal structure when incorporated into a lithium-ion electrochemical cell and cycled from a lower voltage of between 2.0 V to 3.0 V to a higher voltage of between 4.4 V to 4.8 V for 100 charge-discharge cycles at 30° C.

6. A lithium-ion electrochemical cell according to claim 3, wherein the metal oxide active material has the formula, Li[M²_{y}M³_{1-2y}M³_{1-2y}Mn_{y}]O₂, wherein 0.167<y<0.5, M² represents Ni or Ni and Li, and M³ represents Co, and wherein said metal oxide active material is in the form of a single phase having an O3 crystal structure.

7. A lithium-ion electrochemical cell according to claim 6, wherein the metal oxide active material does not undergo a phase transformation to a spinel crystal structure when incorporated into a lithium-ion electrochemical cell and cycled from a lower voltage of between 2.0 V to 3.0 V to a higher voltage of between 4.4 V to 4.8 V for 100 charge-discharge cycles at 30° C.

8. A lithium-ion electrochemical cell according to claim 3, wherein the metal oxide active material has the formula, Li[M⁴_{y}M⁵_{1-2y}Mn_{y}]O₂, wherein 0.167<y<0.5, M⁴ represents Ni and M⁵ represents Co or Co and Li, and wherein said metal oxide active material is in the form of a single phase having an O3 crystal structure.

9. A lithium-ion electrochemical cell according to claim 8, wherein the metal oxide active material does not undergo a phase transformation to a spinel crystal structure when incorporated into a lithium-ion electrochemical cell and cycled from a lower voltage of between 2.0 V to 3.0 V to a higher voltage of between 4.4 V to 4.8 V for 100 charge-discharge cycles at 30° C.

10. A lithium-ion electrochemical cell according to claim 1, wherein the alloy active material comprises:
silicon, tin, or a combination thereof;
optionally, aluminum;
at least one transition metal;
optionally, yttrium, a lanthanide element, an actinide element, or combinations thereof; and
optionally, carbon.

11. A lithium-ion electrochemical cell according to claim 10, wherein the silicon, if present, is present in greater than 55 mole percent.

12. A lithium-ion electrochemical cell according to claim 10, wherein the transition metal is selected from titanium, cobalt, iron, and combinations thereof.

13. A lithium-ion electrochemical cell according to claim 10, wherein the alloy active material is selected from a material having the following component elements, SiAlFeTiSnMm, SiFeSn, SiAlFe, SnCoC, and combinations thereof wherein Mm is a mischmetal that comprises lanthanide elements.

14. A lithium-ion electrochemical cell according to claim 13, wherein the negative electrode comprises Si₆₀Al₁₄Fe₈TiSn₇Mm₁₀, Si₇₁Fe₂₅Sn₄, Si₅₇Al₂₈Fe₁₅, Sn₃₀Co₃₀C₄₀, or combinations thereof.

15. A lithium-ion electrochemical cell according to claim 10, wherein the active alloy material is a mixture of an amorphous phase that includes silicon and a nanocrystalline phase that includes an intermetallic compound that comprises tin.

16. A lithium-ion electrochemical cell according to claim 1, wherein the composite positive electrode, the composite negative electrode, further comprise at least one of graphite, a conductive diluent, or a binder

17. A lithium-ion electrochemical cell according to claim 1, wherein the composite positive electrode, the composite negative electrode or both have a porosity of greater than about 20%.

18. A lithium-ion electrochemical cell according to claim 1 having a capacity of greater than about 3.0 Ah.

19. A lithium-ion electrochemical cell according to claim 13 having a capacity of greater than about 3.5 Ah.

20. An electronic device comprising an electrochemical cell according to claim 1.

21. A method of making an electrochemical cell having high capacity comprising:
providing a composite negative electrode comprising an alloy active material, the negative electrode having a first cycle irreversible capacity of 10 percent or higher and;
selecting a composite positive electrode comprising a metal oxide active material, positive the electrode having a first cycle irreversible capacity within 40 percent of the first cycle irreversible capacity of the negative electrode; and
combining the composite negative electrode, the composite positive electrode, and an electrolyte to form an electrochemical cell.

22. A method of making an electrochemical cell according to claim 21, wherein the composite positive electrode has a first cycle irreversible capacity within 20 percent of the first cycle irreversible capacity of the composite negative electrode.

23. A method of making an electrochemical cell according to claim 21, wherein the metal oxide active material comprises cobalt, nickel, manganese, lithium, or combinations thereof.

24. A method of making an electrochemical cell according to claim 21, wherein the alloy active material comprises:
silicon, tin, or a combination thereof;
optionally, aluminum;
at least one transition metal;
optionally, yttrium, a lanthanide element, an actinide element, or combinations thereof; and
optionally, active carbon.

25. A method of making an electrochemical cell according to claim 24, wherein the transition metal is selected from titanium, cobalt, iron, and combinations thereof.
